(19) United States
(12) Patent Application Publication
(10) Pub. No.: US 2019/0014762 A1
(43) Pub. Date: Jan. 17, 2019

(54) TANGLE FREE FISHING ROD

(71) Applicant: W.C. Bradley/Zebco Holdings, Inc., Tulsa, OK (US)

(72) Inventors: JOSHUA M. DENTON, Broken Arrow, OK (US); SHAW FURUKAWA, Tulsa, OK (US); JOE LU, Kunshan City (CN); WILLIAM DAVID ADDISON, JR., Broken Arrow, OK (US)

(21) Appl. No.: 16/030,280

(22) Filed: Jul. 9, 2018

Related U.S. Application Data
(60) Provisional application No. 62/531,280, filed on Jul. 11, 2017.

(51) Int. Cl. A01K 87/04

(52) U.S. Cl. CPC A01K 87/04

(57) ABSTRACT

A fishing rod shaft having a line guide body, e.g., a rod tip body and/or a middle line guide body designed to minimize snag locations and that facilitate exiting of fishing line wound around the shaft by flicking the rod in a casting-type motion. The outer surface of the bodies define a line opening for receiving fishing line. The line opening communicates with a line passageway. The outer surface defines a continuous, smooth, uninterrupted surface from the attached end to the terminal end but for the line opening. The line opening and the line passageway preferably define the only path to an exit orifice and the line passageway between the line opening and the exit orifice is continuous and defines no openings. The described configuration eliminates snag locations for a fishing hook or for fishing line except for the openings of the line passageway.

### CROSS REFERENCE TO RELATED APPLICATIONS

This application claims the priority of U.S. Provisional Patent Application No. 62/531,280 entitled “TANGLE FREE FISHING ROD,” filed Jul. 11, 2017, the contents of which are hereby incorporated by reference.

### FIELD OF THE INVENTION

The invention relates to fishing rods. More particularly, the invention relates to fishing rods having a rod tip body and line guides for minimizing snags and for facilitating ease of clearing a fishing line wound around the shaft of the fishing rod.

### BACKGROUND OF THE INVENTION

The most common form of recreational fishing is done with a rod, reel, line, hooks and any one of a wide range of baits. Lures are frequently used in place of bait. The practice of catching or attempting to catch fish with a hook is known as angling.

Fishing tackle is a general term that refers to the equipment used for fishing. Examples of fishing tackle include hooks, lines, sinkers, floats, rods, reels, baits, and lures.

A reel is a mechanical device for holding and spooling fishing line. Reels typically include a line spool, a brake to slow running fish, a handle to retrieve line, and a foot for clamping to a rod. Reel types include casting, spinning, spincast, and fly.

A pole, usually made of fiberglass, graphite or composite materials is referred to as a rod. Different types of rods are available, such as rods for spinning, fly fishing, spincast, baitcasting, offshore trolling, etc. Rods typically have a clamp for holding a reel foot and have guides through which the line runs. The guide at the terminal end of the rod is referred to as a flange ring.

The flange ring and guide rings typically extend at a right angle to the shaft for receiving fishing line that is directed to the flange ring by guide rings located over a length of the shaft. One attempt at minimizing line wrap difficulties relate to providing connecting bars that transition from a location adjacent to the rod to an upper portion of the flange ring. However, such a construction provides additional surfaces for the hook to snag upon.

One difficulty commonly encountered by novices who are attempting to fish is associated with fishing line wrapping around the rod or shaft. The wrapping of fishing line is frustrating for children and others who are attempting to fish. Fishing line may wrap around a rod due to a botched cast, when setting a rod down for some reason, or for other reasons. The difficulties may be compounded if the hook or other tackle become engaged with the flange ring on the tip of the shaft.

### SUMMARY OF THE INVENTION

The fishing rod of the invention is designed to minimize snag locations that can be a source of frustration while fishing. Additionally, the fishing rod of the invention is constructed in such a way that line wrapped around the shaft of the fishing rod can potentially exit the end of the fishing rod by simply flicking the rod in a casting-type motion.

In one embodiment. the fishing rod of the invention includes a butt section having a grip and a reel seat. The butt section has a proximal end and a distal end. A base end of a shaft is affixed to the distal end of the butt section. A typical shaft may have a width of 3 mm proximate a tip end of said shaft. Guide rings are typically affixed to the shaft along a length of the shaft for receiving fishing line from a reel.

A body, such as a rod tip body is affixed to the tip end of the shaft. The rod tip body defines a line passageway, an outer surface, a first end or an attached end and a second end or terminal end. The attached end of the rod tip body is affixed to the tip end of the shaft. The terminal end preferably defines an exit orifice.

The outer surface of the rod tip body defines a line opening for receiving fishing line. The line opening communicates with the line passageway that terminates at an exit orifice. The outer surface of the rod tip body defines a continuous, smooth, uninterrupted surface from the attached end to the terminal end of the rod tip body but for the line opening. The line opening and the line passageway preferably define the only path to the exit orifice and the line passageway between the line opening and the exit orifice is continuous and defines no openings. In one embodiment, the upper surface of the rod tip body defines an elongated line opening having a proximal and a distal end. The described configuration eliminates snag locations for a fishing hook or for fishing line except for the openings of the line passageway.

The rod tip body may be quasi-cylindrical or other smooth tapered shapes that facilitate the exit of wound fishing line over the rod tip body. In one embodiment, the outer surface is comprised of an upper surface, a lower surface, a right surface, and a left surface joined by rounded surfaces. The rod tip body is preferably shaped to taper down to the attached end, which preferably has a size approximately equal to a diameter of the tip end of the shaft so that fishing line that has become wound around the shaft can slide over the fishing reel body with a flick of the fishing rod. The outer surface of said rod tip body preferably transitions from the attached end to the terminal end at less than a 20 degree departure from the longitudinal axis of the shaft, which also facilitates slipping wound fishing line over the rod tip body. More preferably, the departure angle of any side of the rod tip body from the longitudinal axis of the shaft is less than 15 degrees, and more preferably, 12 degrees or less.

In one embodiment, a body, such as one or more middle line guides are affixed to the rod for guiding line between the reel and the rod tip. The middle line guide defines a line passageway, an outer surface, an receiving end and an exit end. The first end or receiving end of the middle line guide receives the rod and defines an orifice for receiving fishing line. The second end or exit end allows the rod to pass through the guide and defines an exit orifice for the fishing line to pass through the guide.

The outer surface of the middle line guide defines a line opening for receiving fishing line. The line opening communicates with a line passageway that terminates at an exit orifice. The outer surface of the middle line guide defines a continuous, smooth, uninterrupted surface from the receiving end to the exit end of the middle line guide but for the line opening. The line opening and the line passageway preferably define the only path to the exit orifice and the line passageway between the line opening and the exit orifice is continuous and defines no openings. In one embodiment, the upper surface of the middle line guide defines an elongated line opening having a proximal and a distal end. The described configuration eliminates snag locations for a fishing hook or for fishing line except for the openings of the line passageway.

The middle line guide may be quasi-cylindrical or other smooth tapered shapes that facilitate the passing over of wound fishing line passed the middle line guide. In one embodiment, the outer surface is comprised of an upper surface, a lower surface, a right surface, and a left surface joined by rounded surfaces. The middle line guide is preferably shaped to taper down to the receiving end, which preferably has a size approximately equal to a diameter of the rod shaft at the installed location so that fishing line that has become wound around the shaft can slide over the middle line guide with a flick of the fishing rod. The outer surface of said middle line guide preferably transitions from the receiving end to the exit end at less than a 20 degree departure from the longitudinal axis of the shaft, which also facilitates slipping wound fishing line over the middle line guide. More preferably, the departure angle of any side of the middle line guide from the longitudinal axis of the shaft is less than 15 degrees, and more preferably, 10 degrees or less.

### BRIEF DESCRIPTION OF THE DRAWINGS

FIG. 1 is a side elevation view of a rod and reel assembly equipped with a rod tip body of the invention.

FIG. 2 is a top plan view of the rod tip body of FIG. 1.

FIG. 3 is a bottom plan view of the rod tip body of FIG. 1.

FIG. 4 is an elevation side view of the rod tip body of FIG. 1.

FIG. 5 is an end elevational view of the rod tip body of FIG. 1.

FIG. 6 is a cross-sectional elevation view of the rod tip body of FIG. 1.

FIG. 7 is a side elevation view of a rod and reel assembly equipped with a rod tip body and middle line guide of the invention.

FIG. 8 is a top plan view of a rod and reel assembly equipped with a rod tip body and middle line guide of the invention.

FIG. 9 is a bottom plan view of a rod and reel assembly equipped with a rod tip body and middle line guide of the invention.

FIG. 10 is a top plan view of the middle line guide of FIG. 7.

FIG. 11 is a bottom plan view of the middle line guide of FIG. 7.

FIG. 12 is a cross-sectional elevation view of the middle line guide of FIG. 7.

### DETAILED DESCRIPTION OF THE PREFERRED EMBODIMENTS

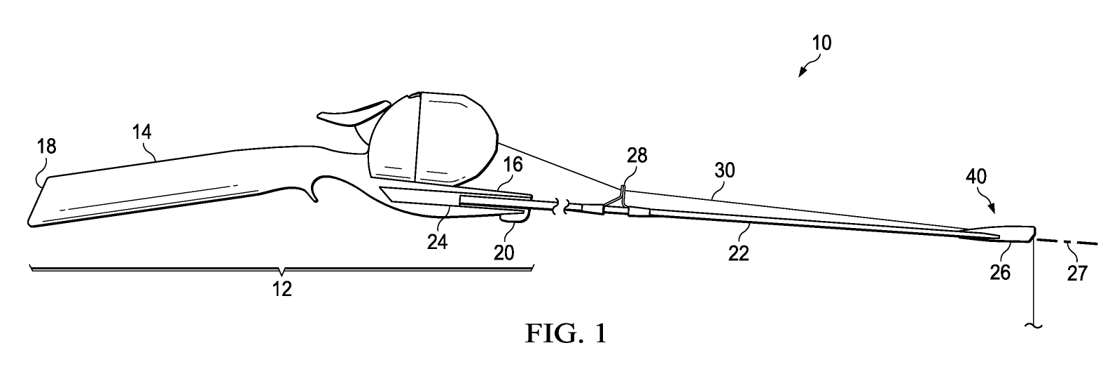

Referring now to FIG. 1, shown is fishing rod designated generally 10. Fishing rod 10 includes butt section 12. Butt section 12 has grip 14 and reel seat 16. Butt section 12 has proximal end 18 and distal end 20.

Fishing rod 10 further includes shaft 22. Shaft 22 has base end 24 and tip end 26. Base end 24 of shaft 22 is affixed to distal end 20 of butt section 12. In one embodiment, shaft 22 has a width of 3 mm proximate to tip end 26 of shaft 22. Shaft 22 defines longitudinal axis 27. One or more guide rings 28 are typically affixed to shaft 22 along a length of shaft 22 for receiving fishing line 30.

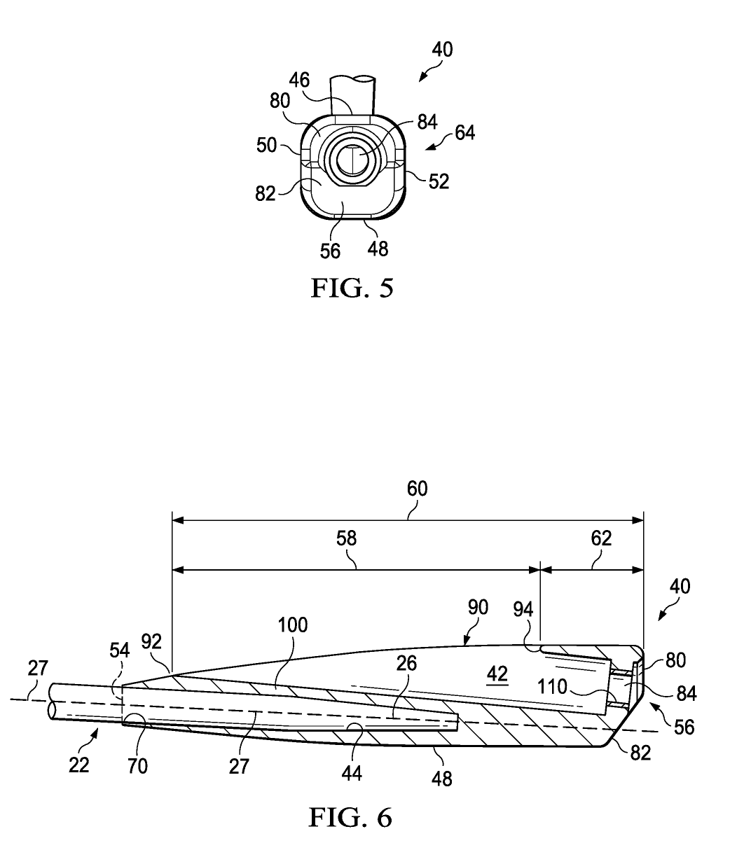

Referring now to FIGS. 1-6, rod tip body 40 is affixed to tip end 26 of shaft 22. Rod tip body 40 defines line passageway 42 (FIG. 6), receiving cavity 44, upper surface 46, lower surface 48, right surface 50, left surface 52, attached end 54, terminal end 56, entry portion 58, line channel portion 60, and enclosed portion 62.

Upper surface 46, lower surface 48, left surface 50 and right surface 52 define an outer surface 64 of rod tip body 40. Outer surface 64 may be made up of flat sides 46, 48, 50 and 52 connected by rounded interfaces, as is shown in the Figures. Alternatively, outer surface 64 may be cylindrical, quasi-cylindrical, or of another cross-sectional shape. Any cross-sectional view of rod tip body 40 taken along a plane having a line intersection with longitudinal axis 27 preferably exhibits no surfaces that slope away from longitudinal axis 27 at a slope greater than 20 degrees, e.g., see angle A of FIG. 6. The described configuration facilitates sliding of a fishing line over the rod tip body 40, even if line has wrapped around shaft 22. The ability to slip wrapped line past rod tip body 40 is an important feature, especially for children's rods, but is desirable for all users of fishing rod 10.

Additionally, any cross-sectional view of rod tip body 40 taken along a plane having a line intersection with longitudinal axis 27 exhibits no surfaces that are not smooth. Smooth surfaces may be defined as surfaces that follow a smooth curve. A smooth curve may be defined as a curve that is continuous and has a continuous derivative or is differentiable at every point. Another definition of a smooth curve is, “a curve with a continuously turning tangent” (“Smooth Curve.” Merriam-Webster.com. Merriam-Webster, n.d. Web. 21 Jun. 2017). The described configuration facilitates sliding of a fishing line over the rod tip body 40, even if line has wrapped around shaft 22. The ability to slip wrapped line past rod tip body 40 is an important feature, especially for children's rods, but is desirable for all users of fishing rod 10.

Attached end 54 of rod tip body 40 defines receiving orifice 70 (FIG. 6). Receiving orifice 70 is for receiving tip end 26 of shaft 22. Receiving orifice 70 is in communication with receiving cavity 44 wherein receiving cavity 44 extends from attached end 54 and into entry portion 58 of rod tip body 40. In one embodiment, receiving orifice 70 has a diameter of 3 mm for tightly engaging tip end 26 of shaft 22.

Terminal end 56 of rod tip body 40 defines exit surface 80 and chamfered surface 82. Exit surface 80 defines exit orifice 84.

In one embodiment, terminal end 56 of rod tip body 40 has a width that is three times the width of shaft 22 proximate to tip end 26 of shaft 22.

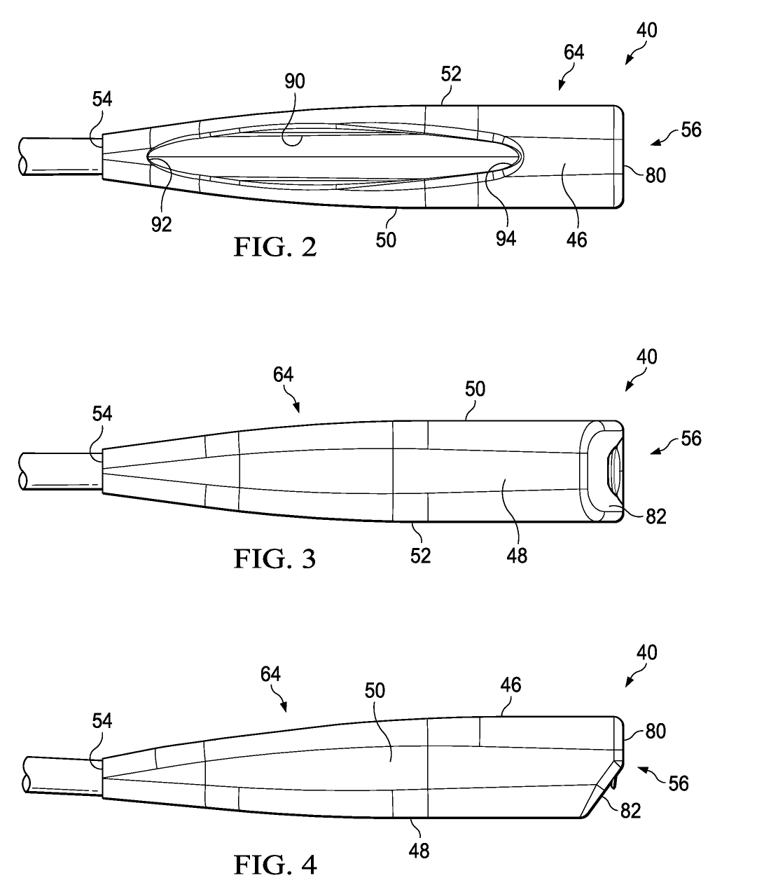

Upper surface 46 of rod tip body 40 defines line opening 90 having proximal end 92 and distal end 94 (FIGS. 2 and 6). Line channel opening 90 is in communication with line passageway 42. Upper surface 46 of rod tip body 40 defines a continuous uninterrupted surface from attached end 54 to terminal end 56 of rod tip body 40. Upper surface 46 additionally defines a continuous uninterrupted surface from right side 96 to left side 98 of upper surface 46 but for line channel opening 90. The continuous uninterrupted surface avoids hook snag locations.

In one embodiment, upper surface 46 of rod tip body 40 smoothly slopes away from shaft 22 at 12 degrees, i.e., has a slope with a departure angle represented by angle A, shown in FIG. 6. However, other angles are also contemplated including angles of less than 20 degrees, less than 15 degrees, and 12 degrees and less.

Lower surface 48 of rod tip body 40 defines a continuous uninterrupted surface from attached end 54 to terminal end 56 of rod tip body 40 and from right surface 50 to left surface 52 for avoiding hook snag locations.

In one embodiment, lower surface 48 smoothly slopes away from shaft 22 at a departure angle of 3 degrees.

Left surface 52 defines a continuous uninterrupted surface from attached end 54 to terminal end 56 of rod tip body 40 and from upper surface 46 to lower surface 48 of rod tip body 40 for avoiding hook snag locations.

In one embodiment, left surface 52 smoothly slopes away from shaft 22 at 12 degrees. In one embodiment, left surface 52 has a maximum height of 0.9 mm.

Right surface 50 defines a continuous uninterrupted surface from attached end 54 to terminal end 56 of rod tip body 40 and from upper surface 46 to lower surface 48 of rod tip body 40 for avoiding hook snag locations.

In one embodiment, right surface 50 smoothly slopes away from shaft 22 at 12 degrees. In one embodiment, right surface 52 has a maximum height of 0.99 mm.

Line passageway 42 extends from proximal end 92 of line channel opening 90 through enclosed portion 62 of rod tip body 40 and line passageway 42 extends to exit orifice 84 of rod tip body 40.

Rod tip body 40 defines a divider portion 100 that separates a lower surface of line passageway 42 from an upper surface of receiving cavity 44. Insert 110 is received in exit orifice 84 and extends into line passageway 42. Insert 110 defines a smooth path for receiving fishing line 30.

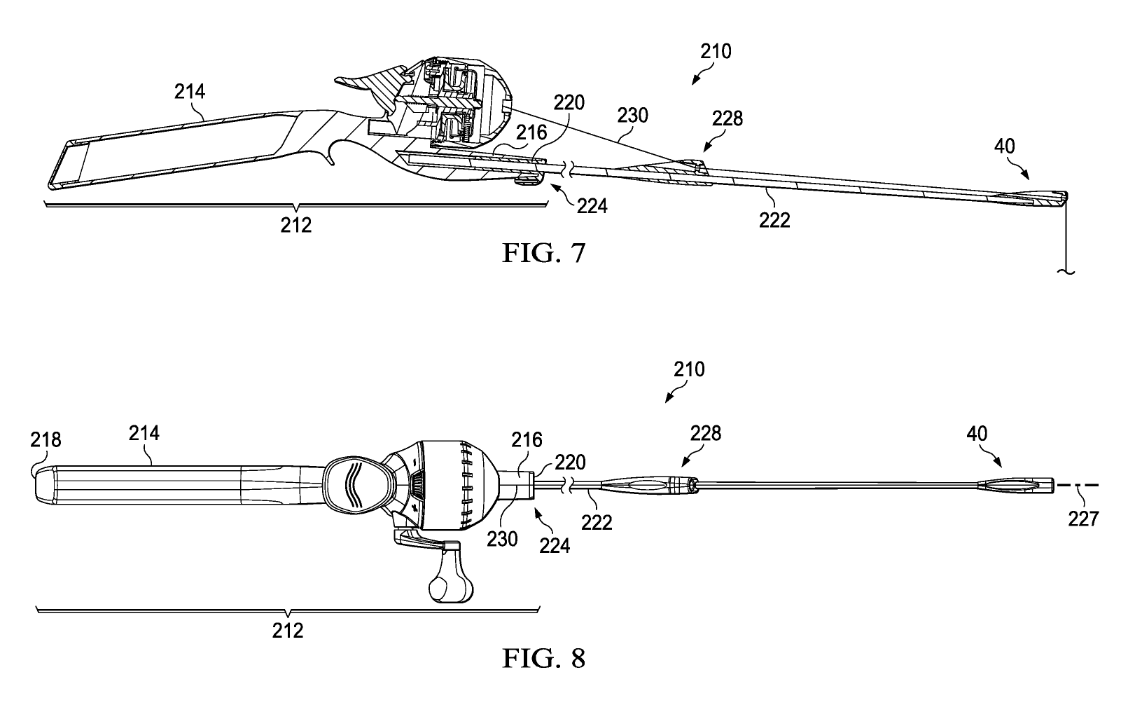

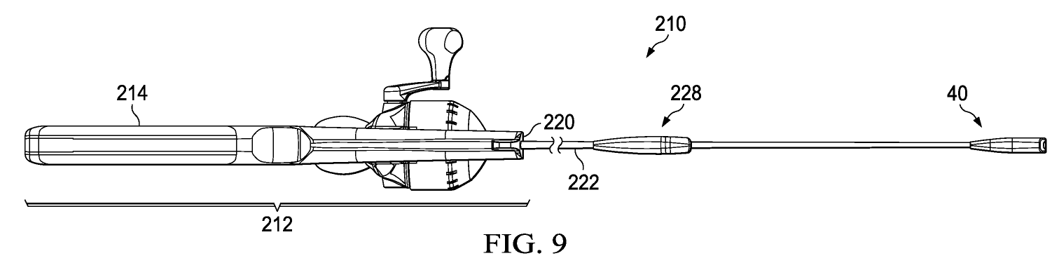

Referring now to FIGS. 7-9, shown is fishing rod designated generally 210. Fishing rod 210 includes butt section 212. Butt section 212 has grip 214 and reel seat 216. Butt section 212 has proximal end 218 and distal end 220.

Fishing rod 210 further includes shaft 222. Shaft 222 has base end 224 and tip end 226. Base end 224 is affixed to distal end 220 of butt section 212. In one embodiment, shaft 222 has a width of 3 mm proximate to tip end 226 of shaft 222. Shaft 222 defines longitudinal axis 227. One of a middle line guide 228 is affixed to shaft 222 along a length of shaft 222 for receiving fishing line 230.

Referring now to FIGS. 7-12, rod tip body 40 is affixed to tip end 226 of shaft 222 and middle line guide 228 is affixed to a middle area of shaft 222. Middle line guide 228 defines line passageway 242 (best seen in FIG. 12), shaft receiving passageway 244, upper surface 246, lower surface 248, right surface 250, left surface 252, receiving end 254, exit end 256, entry portion 258, line channel portion 260, and enclosed portion 262.

Upper surface 246, lower surface 248, left surface 250 and right surface 252 define an outer surface 264 of middle line guide 228. Outer surface 264 may be made up of flat sides 246, 248, 250 and 252 connected by rounded interfaces, as is shown in the Figures. Alternatively, outer surface 264 may be cylindrical, quasi-cylindrical, or of another cross-sectional shape. Any cross-sectional view of middle line guide 228 taken along a plane having a line intersection with longitudinal axis 227 preferably exhibits no surfaces that slope away from longitudinal axis 227 at a slope greater than 20 degrees, e.g., see angle B of FIG. 12. The described configuration facilitates sliding of a fishing line over middle line guide 228, even if line has wrapped around shaft 222. The ability to slip wrapped line past middle line guide 228 is an important feature, especially for children's rods, but is desirable for all users of fishing rod 210.

Additionally, any cross-sectional view of middle line guide 228 taken along a plane having a line intersection with longitudinal axis 227 exhibits no surfaces that are not smooth. Smooth surfaces may be defined as set forth above, with regards to the embodiment of FIGS. 1-6. The described configuration facilitates sliding of a fishing line over the middle line guide 228, even if line has wrapped around shaft 222. The ability to slip wrapped line passed middle line guide 228 is an important feature, especially for children's rods, but is desirable for all users of fishing rod 210.

Receiving end 254 of middle line guide 228 defines shaft receiving orifice 270 (FIG. 12). Shaft receiving orifice 270 is for receiving tip a middle portion of shaft 222. Shaft receiving orifice 270 is in communication with shaft receiving passageway 244 wherein shaft receiving passageway 244 extends from receiving end 254 and through a length of the body of middle line guide 228. Shaft receiving orifice 270 is sized to tightly engage shaft 222.

Exit end 256 of middle line guide 228 defines exit orifice 284.

In one embodiment, exit end 256 of middle line guide 228 has a width that is three times the width of a middle portion of shaft 222 to which middle line guide 228 is affixed.

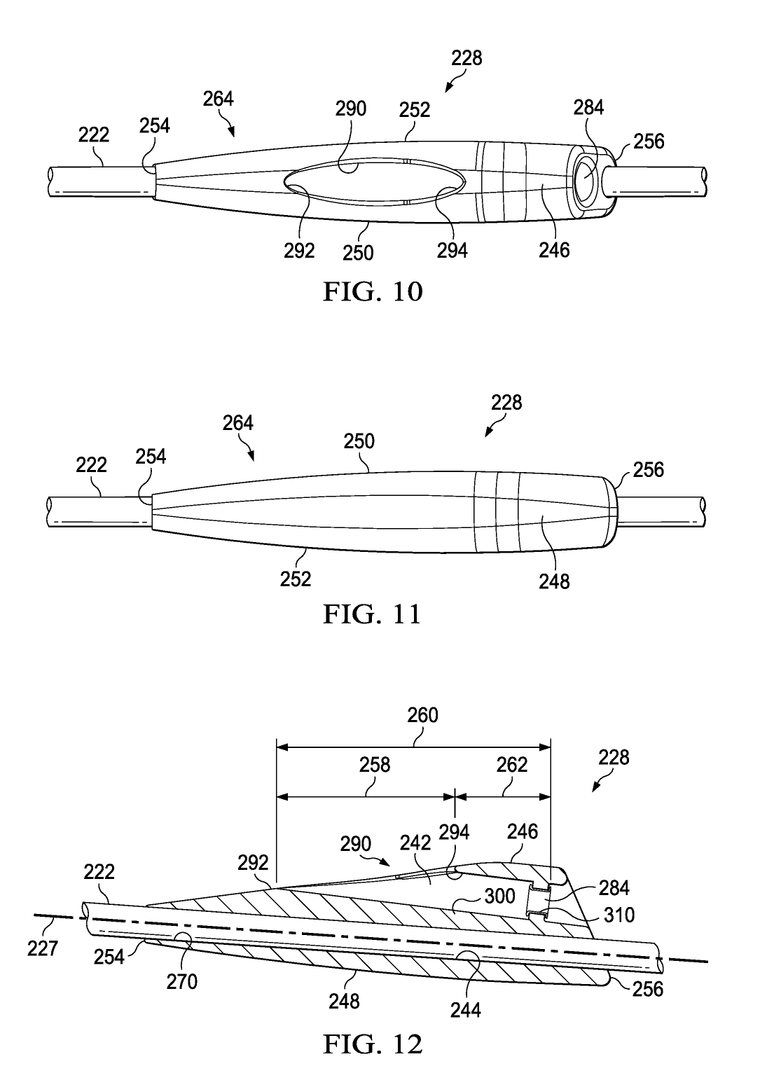

Upper surface 246 of middle line guide 228 defines line channel opening 290 having proximal end 292 and distal end 294 (FIGS. 10 and 12). Line channel opening 290 is in communication with line passageway 242. Upper surface 246 of middle line guide 228 defines a continuous uninterrupted surface from receiving end 254 to exit end 256 of middle line guide 228. Upper surface 246 additionally defines a continuous uninterrupted surface from right side 296 to left side 298 of upper surface 246 but for line channel opening 290. The continuous uninterrupted surface avoids hook snag locations.

In one embodiment, upper surface 246 of middle line guide 228 smoothly slopes away from shaft 222 at 12 degrees, i.e., has a slope with a departure angle represented by angle B, shown in FIG. 12. However, other angles are also contemplated including angles of 20 degrees or less, less than 15 degrees, 12 degrees and less, and 5 degrees and less.

Lower surface 248 of middle line guide 228 defines a continuous uninterrupted surface from receiving end 254 to exit end 256 of middle line guide 228 and from right side 296 to left side 298 for avoiding hook snag locations.

In one embodiment, lower surface 248 smoothly slopes away from shaft 222 at a departure angle of 3 degrees, although other angles are contemplated as being effective.

Left surface 250 defines a continuous uninterrupted surface from receiving end 254 to exit end 256 of middle line guide 228 and from upper surface 246 to lower surface 248 of middle line guide 228 for avoiding hook snag locations.

In one embodiment, left surface 250 smoothly slopes away from shaft 222 at 12 degrees. In one embodiment, left surface 248 has a maximum height of 0.9 mm.

Right surface 252 defines a continuous uninterrupted surface from receiving end 254 to exit end 256 of middle line guide 228 and from upper surface 246 to lower surface 248 of middle line guide 228 for avoiding hook snag locations.

In one embodiment, right surface 252 smoothly slopes away from shaft 222 at 12 degrees. In one embodiment, right surface 252 has a maximum height of 0.99 mm.

Line passageway 242 extends from proximal end 292 of line channel opening 290 through enclosed portion 262 of middle line guide 228 and line passageway 242 extends to exit orifice 284 of middle line guide 228.

Middle line guide 228 defines a divider portion 300 that separates a lower surface of line passageway 242 from an upper surface of shaft receiving cavity 244. Insert 310 is received in exit orifice 284 and extends into line passageway 242. Insert 310 defines a smooth path for receiving fishing line 230.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A fishing rod comprising:
a shaft having a base end, a tip end, and a longitudinal axis;
a body affixed to said shaft, said body defining a line passageway, an outer surface, a first end and a second end;
wherein said outer surface of said body defines a line opening, said line opening in communication with said line passageway, said outer surface defining a continuous, uninterrupted surface from said first end to said second end of said body but for said line opening for avoiding hook snag locations;
wherein said body tapers to said first end, said first end having a size approximately equal to a diameter of said shaft, said outer surface of said body transitioning from said first end to said second end at less than a 20 degree departure from said longitudinal axis of said shaft for allowing a line to slip over said body.

2. The fishing rod according to claim 1 wherein:
said body is a rod tip body that is affixed to said tip end of said shaft.

3. The fishing rod according to claim 1 wherein:
said body is a middle line guide body affixed to a middle portion of said shaft.

4. The fishing rod according to claim 1 wherein:
said second end of said body defines an exit orifice;
wherein said line opening and said line passageway define the only path to said exit orifice for reducing line snag locations.

5. The fishing rod according to claim 1 wherein:
said outer surface of said body is smooth.

6. The fishing rod according to claim 1 wherein:
said body defines an exit orifice;
said line passageway is in communication with said line opening and said exit orifice;
wherein said line passageway between said line opening and said exit orifice is continuous and defines no openings.

7. The fishing rod according to claim 1 wherein:
said outer surface of said body is comprised of an upper surface, a lower surface, a right surface, and a left surface;
said upper surface defining a right side, a left side and said line opening, said line opening in communication with said line passageway, said upper surface defining a continuous, uninterrupted surface from said first end to said second end of said body and from said right side to said left side of said upper surface but for said line opening for avoiding hook snag locations;
wherein said lower surface of said body defines a continuous, uninterrupted surface from said first end to said second end of said body and from a right side to a left side of said lower surface for avoiding hook snag locations;
wherein said left surface and said right surface define a continuous, uninterrupted surface from said first end to said second end of said body and from said upper surface to said lower surface of said body for avoiding hook snag locations.

8. A fishing rod comprising:
a shaft having base end and a tip end;
a body affixed to said shaft, said body defining a line passageway, an outer surface, a first end, and a second end;
said outer surface of said body defines a line opening having a proximal end and a distal end, said line opening in communication with said line passageway, said outer surface defining a continuous, uninterrupted surface from said first end to said second end of said body but for said line opening for avoiding hook snag locations;
wherein said outer surface of said body is smooth.

9. The fishing rod according to claim 8 wherein:
said body is a rod tip body that is affixed to said tip end of said shaft.

10. The fishing rod according to claim 8 wherein:
said body is a middle line guide body affixed to a middle portion of said shaft.

11. The fishing rod according to claim 8 wherein:
said second end of said body defines an exit orifice;
wherein said line opening and said line passageway define the only path to said exit orifice for reducing line snag locations.

12. The fishing rod according to claim 8 wherein:
wherein the shaft has a longitudinal axis;
wherein said body tapers to said first end, said first end having a size approximately equal to a diameter of said shaft, said outer surface of said body transitioning from said first end to said second end at less than a 20 degree departure from said longitudinal axis of said shaft for allowing a line to slip over said body.

13. The fishing rod according to claim 8 wherein:
said body defines an exit orifice;
said line passageway in communication with said line opening and said exit orifice;
wherein said line passageway between said line opening and said exit orifice is continuous and defines no openings.

14. The fishing rod according to claim 8 wherein:
said outer surface of said body is comprised of an upper surface, a lower surface, a right surface, and a left surface;
said upper surface of said body defines said line opening, said line opening in communication with said line passageway, said upper surface defining a continuous, uninterrupted surface from said first end to said second end of said body and from a right side to a left side of said upper surface but for said line opening for avoiding hook snag locations;
wherein said lower surface of said body defines a continuous, uninterrupted surface from said first end to said second end of said body and from a right side to a left side of said lower surface for avoiding hook snag locations;
wherein said left surface and said right surface define a continuous, uninterrupted surface from said first end to said second end of said body and from said upper surface to said lower surface of said body for avoiding hook snag locations.

15. A fishing rod comprising:
a shaft having a base end, a tip end, and a longitudinal axis;
a body affixed to said shaft, said body defining a line passageway, a receiving cavity, an outer surface, a first end, a second end, and a line opening;
wherein said second end of said body defines an exit orifice;
wherein said line opening and said line passageway define the only path to said exit orifice for reducing line snag locations;
wherein said body tapers to said first end, said first end having a size approximately equal to a diameter of said shaft, said outer surface of said body transitioning from said first end to said second end at less than a 20 degree departure from said longitudinal axis of said shaft for allowing a line to slip over said body.

16. The fishing rod according to claim 15 wherein:
said body is a rod tip body that is affixed to said tip end of said shaft.

17. The fishing rod according to claim 15 wherein:
said body is a middle line guide body affixed to a middle portion of said shaft.

18. The fishing rod according to claim 15 wherein:
said outer surface of said body defines said line opening, said line opening in communication with said line passageway, said outer surface defining a continuous, uninterrupted surface from said first end to said second end of said body but for said line opening for avoiding hook snag locations.

19. The fishing rod according to claim 15 wherein:
said outer surface of said body is comprised of an upper surface, a lower surface, a left surface and a right surface;
said upper surface of said body defining said line opening, said line opening in communication with said line passageway, said upper surface defining a continuous, uninterrupted surface from said first end to said second end of said body and from a right side to a left side of said upper surface but for said line opening for avoiding hook snag locations;
wherein said lower surface of said body defines a continuous, uninterrupted surface from said first end to said second end of said body and from a right side to a left side of said lower surface for avoiding hook snag locations;
wherein said left surface and said right surface define a continuous, uninterrupted surface from said first end to said second end of said body and from said upper surface to said lower surface of said body for avoiding hook snag locations.

20. The fishing rod according to claim 15 wherein:
said outer surface of said body is smooth.

21. The fishing rod according to claim 15 wherein:
said line passageway is in communication with said line opening and said exit orifice;
wherein said line passageway between said line opening and said exit orifice is continuous and defines no openings.

22. A fishing rod comprising:
a shaft having a base end and a tip end;
a body affixed to said shaft, said body defining a line passageway, an outer surface, a first end, a second end, and a line opening;
said second end of said body defines an exit orifice;
wherein said line opening and said line passageway define the only path to said exit orifice for reducing line snag locations; and
wherein said outer surface of said body is smooth.

23. The fishing rod according to claim 22 wherein:
said body is a rod tip body that is affixed to said tip end of said shaft.

24. The fishing rod according to claim 22 wherein:
said body is a middle line guide body affixed to a middle portion of said shaft.

25. The fishing rod according to claim 22 wherein:
said outer surface of said body defines said line opening, said line opening in communication with said line passageway, said outer surface defining a continuous, uninterrupted surface from said first end to said second end of said body but for said line opening for avoiding hook snag locations.

26. The fishing rod according to claim 22 wherein:
said outer surface is comprised of an upper surface, a lower surface, a right surface and a left surface;
said upper surface of said body defining said line opening, said line opening in communication with said line passageway, said upper surface defining a continuous, uninterrupted surface from said first end to said second end of said body and from a right side to a left side of said upper surface but for said line opening for avoiding hook snag locations;
wherein said lower surface of said body defines a continuous, uninterrupted surface from said first end to said second end of said body and from a right side to a left side of said lower surface for avoiding hook snag locations;
wherein said left surface and said right surface defines a continuous, uninterrupted surface from said first end to said second end of said body and from said upper surface to said lower surface of said body for avoiding hook snag locations.

27. The fishing rod according to claim 22 wherein:
wherein the shaft has a longitudinal axis;
wherein said body tapers to said first end, said first end having a size approximately equal to a diameter of said shaft, said outer surface of said body transitioning from said first end to said second end at less than a 20 degree departure from said longitudinal axis of said shaft for allowing a line to slip over said body.

28. The fishing rod according to claim 22 wherein:
said body defines an exit orifice;
said line passageway is in communication with said line opening and said exit orifice;
wherein said line passageway between said line opening and said exit orifice is continuous and defines no openings.

29. A fishing rod comprising:
a shaft having a base end, a tip end, and a longitudinal axis;
a body affixed to said shaft, said body defining a line passageway, an outer surface, a first end, a second end, and a line opening;
said second end of said body defines an exit orifice;
said line passageway in communication with said line opening and said exit orifice;
wherein said line passageway between said line opening and said exit orifice is continuous and defines no openings;
wherein said body tapers to said first end, said first end having a size approximately equal to a diameter of said tip end of said shaft, said outer surface of said body transitioning from said first end to said second end at less than a 20 degree departure from said longitudinal axis of said shaft for allowing a line to slip over said body.

30. The fishing rod according to claim 29 wherein:
said body is a rod tip body that is affixed to said tip end of said shaft.

31. The fishing rod according to claim 29 wherein:
said body is a middle line guide body affixed to a middle portion of said shaft.

32. The fishing rod according to claim 29 wherein:
said outer surface of said body defines said line opening, said line opening in communication with said line passageway, said outer surface defining a continuous, uninterrupted surface from said first end to said second end of said body but for said line opening for avoiding hook snag locations.

33. The fishing rod according to claim 29 wherein:
said outer surface of said body is comprised of an upper surface, a lower surface, a right surface and a left surface;
said upper surface of said body defining said line opening, said line opening in communication with said line passageway, said upper surface defining a continuous, uninterrupted surface from said first end to said second end of said body and from a right side to a left side of said upper surface but for said line opening for avoiding hook snag locations;
wherein said lower surface of said body defines a continuous, uninterrupted surface from said first end to said second end of said body and from a right side to a left side of said lower surface for avoiding hook snag locations;
wherein said left surface and said right surface define a continuous, uninterrupted surface from said first end to said second end of said body and from said upper surface to said lower surface of said body for avoiding hook snag locations.

34. The fishing rod according to claim 29 wherein:
wherein said line opening and said line passageway define the only path to said exit orifice for reducing line snag locations.

35. The fishing rod according to claim 29 wherein:
said outer surface of said body is smooth.

36. A fishing rod comprising:
a shaft having base end and a tip end;
a body affixed to said shaft, said body defining a line passageway, an outer surface, a first end, and a second end;
said body defines a line opening and an exit orifice;
said line passageway in communication with said line opening and said exit orifice;
wherein said line passageway between said line opening and said exit orifice is continuous and defines no openings; and
wherein said outer surface of said body is smooth.

37. The fishing rod according to claim 36 wherein:
said body is a rod tip body that is affixed to said tip end of said shaft.

38. The fishing rod according to claim 36 wherein:
said body is a middle line guide body affixed to a middle portion of said shaft.

39. The fishing rod according to claim 36 wherein:
said outer surface of said body defines said line opening, said line opening in communication with said line passageway, said outer surface defining a continuous, uninterrupted surface from said first end to said second end of said body but for said line opening for avoiding hook snag locations.

40. The fishing rod according to claim 36 wherein:
said outer surface of said body is comprised of an upper surface, a lower surface, a right surface and a left surface;
said upper surface of said body defining said line opening, said line opening in communication with said line passageway, said upper surface defining a continuous, uninterrupted surface from said first end to said second end of said body and from a right side to a left side of said upper surface but for said line opening for avoiding hook snag locations;
wherein said lower surface of said body defines a continuous, uninterrupted surface from said first end to said second end of said body and from a right side to a left side of said lower surface for avoiding hook snag locations;
wherein said left surface and said right surface define a continuous, uninterrupted surface from said first end to said second end of said body and from said upper surface to said lower surface of said body for avoiding hook snag locations.

41. The fishing rod according to claim 36 wherein:
said second end of said body defines said exit orifice;
wherein said line opening and said line passageway define the only path to said exit orifice for reducing line snag locations.

42. The fishing rod according to claim 36 wherein:
said shaft has a longitudinal axis;
wherein said body tapers to said first end, said first end having a size approximately equal to a diameter of said shaft, said outer surface of said body transitioning from said first end to said second end at less than a 20 degree departure from said longitudinal axis of said shaft for allowing a line to slip over said body.
